(19) United States
(12) Patent Application Publication
(10) Pub. No.: US 2015/0317331 A1
(43) Pub. Date: Nov. 5, 2015

(54) UNIFIED PLATFORM FOR APPLICATION DEVELOPMENT

(71) Applicant: DhiLogics Solutions India Pvt. Ltd., Cochin (IN)

(72) Inventors: Liju THOMAS, Kochi (IN); Ajith NAMBIARUVEETIL, Kochi (IN)

(73) Assignee: DhiLogics Solutions India Pvt. Ltd., Cochin (IN)

(21) Appl. No.: 14/702,240

(22) Filed: May 1, 2015

Related U.S. Application Data
(60) Provisional application No. 61/987,701, filed on May 2, 2014.

(51) Int. Cl. G06F 17/30; G06F 9/44

(52) U.S. Cl. CPC G06F 17/30233; G06F 8/35

(57) ABSTRACT

A method to generate an entity model, comprising receiving a selection of one or more databases, receiving connection specifying between data elements of one or more databases and setting of connection, retrieving a data model of one or more databases, the data model comprising a set of database elements, generating a virtual model framework of one or more databases.

### FIELD OF THE INVENTION

The present invention relates to tool which are used to develop a unified framework for application software development, and more particularly for generating a virtual unified database model.

### BACKGROUND OF THE INVENTION

In current scenario, lot of business users and companies need to have their business data scattered into multiple different databases. The requirement of using multiple databases could be due to presence of important and non-transferrable data in legacy systems and modern data centres at same time.

Database aware software application development is performed using an application programming interface (API) involving query languages (e.g., SQL used to access relational data sources). The API works for connecting programs written in a programming language to a variety of available databases.

Among one of the known techniques of using multiple databases for an application development is where database server capacity is increased. The approach is helpful as it is simple and does not require any architectural changes. However, large servers are usually very expensive in per unit of performance than smaller servers, and have fundamental scalability limitations.

Another technique used is by having a multi partition approach, which divides a large database into separate smaller databases. This mandates rewriting existing applications in a way that smartly access separate databases. At same time, development of new applications is difficult as it requires additional logic, enabling access to separate databases.

Software application development teams find it difficult to develop applications involving access to multiple different databases at the same time. Software application development has its own overhead and takes own course of time, but the complexity of using multiple different databases, at the same time, makes it tougher, complex, costlier and more time consuming job.

With these, the developer efforts for developing a quality application grow multi-fold as requirements or complexity of the different database access increases. In absence of any reliable, standard, uniform, cost effective, hassle free environment for connecting multiple different databases to code of an application program, and no availability of common tools for accessing multiple databases together across platforms. Developers are forced to manage between various tools, spending quality time unnecessarily to even get a multi-database aware application up and running before writing the core of the application, resulting in added cost to the application development process.

### SUMMARY OF THE INVENTION

To overcome limitations in the prior art, and to overcome other limitations that will become apparent upon reading and understanding the present specification, the present invention discloses a system and method for providing a comprehensive framework for unified application software development.

In accordance with one embodiment of the invention, a method for providing a platform with a unified framework having a single virtual model of tables from one or multiple databases, wherein linking across tables belonging to the one or multiple databases is performed, thereby assisting in creation of new models around databases, and generating a unified view of the models, without reference that the models belong to different multiple databases.

One another embodiment of the present invention provides a system that enables automatic generation of a virtual database model in order to support a customized pattern of database tables across one or more source databases. In one embodiment, a metadata manager component is configured to facilitate creation of the model. A virtual unified model generator component generates the virtual database model by analysing the database table models, automatically generating and storing a database query statement that, when executed, causes a retrieval of data consistent with data location indicators included.

Another embodiment of the present invention includes a method or system wherein application development targets these unified models and the framework will take care of directing or getting the data from underlying databases (DB). In other embodiments, multiple databases such as SQL databases like MySQL, Oracle, SQL Server, DB2; noSQL databases like MongoDB, any webservices that provides access to data, file systems etc. can be supported through this framework. A database is any collection of information that is organized so that it can easily be accessed, managed, and updated. Which can be a relational DB, non-relational DBs like network DB, nosql DB, file systems or even other applications acting as data sources for databases Unified Platform can also have its own database and entity models. Additional databases can be supported through this framework by extending and customizing the database driver files.

Another embodiment of the present invention includes a method or system wherein a unified model by a metadata driven approach is used for the application development, wherein dragging and dropping creates the application screens.

Another embodiment of the present invention includes a method or system wherein configuring of business process uses Trays wherein writing custom code either in the back end or in the front end to customize the application is performed.

Another embodiment of the present invention includes a method or system wherein the platform allows an in memory reporting against the unified model and thereby generating reports with data coming from multiple databases.

The embodiments of the present invention provide application development tools that allow developers to quickly build multi database aware and supported applications with unified access model framework, including from an existing database query, from existing application code that accesses a database, and hybrids or variations of these approaches.

Another embodiment of the present invention includes a computer program product comprising a computer useable storage medium having a computer readable program, where the computer readable program when executed on a computer causes the computer to perform an operation. The operation may generally include generating a virtual database model in order to support a customized pattern of database tables across one or more source databases, configuring a metadata manager component to facilitate creation of the model, generating the virtual database model by analysing the database table models by a virtual unified model generator component, automatically generating and storing a database query statement that, when executed, causes a retrieval of data consistent with data location indicators included.

In one embodiment, a method to generate an entity model or a database model, comprising receiving a selection of one or more databases, receiving connection specifying between data elements of one or more databases and setting of connection, retrieving a data model of one or more databases, the data model comprising a set of database elements, generating a virtual model framework of one or more databases.

In another embodiment a computer program product comprising a computer useable storage medium having a computer readable program, wherein the computer readable program when executed on a computer causes the computer to perform an operation comprising receiving a selection of one or more databases, receiving connection specifying between data elements of one or more databases and setting of connection, retrieving a data model of one or more databases, the data model comprising a set of database elements, generating a virtual model framework of one or more databases.

In yet another embodiment a system, comprising a processor, and a memory containing a virtual model generator component configured to generate virtual model framework of one or more databases, performing an operation, comprising receiving a selection of one or more databases, receiving connection specifying between data elements of one or more databases and setting of connection, retrieving a data model of one or more databases, the data model comprising a set of database elements, generating a virtual model framework of one or more databases.

In an embodiment, a unified platform is generated using an entity model or database model from one or more databases to build an application. The unified platform exposes application program interface to edit data from internal entities or external entities, wherein the unified platform provides custom connectors to be plugged in for any external data sources. The method builds at least one entity models and at least one relation between internal entities and external entities. The model further collects metadata of the data models and stores in a metadata repository.

In one further embodiment, a unified platform exposes application program interface to edit data from internal entities or external entities. A relation is build between internal entities and external entities. The relation is build between internal entities and external entities with one to many relationship by adding reference keys of external entities in metadata of internal entity or a relation is build between two external entities with one to many relationship by adding reference keys of one entity to other entity in metadata. Further, a relation can be build between internal entities and external entities with many to one relationship by adding reference keys of internal entity to external entity metadata or a relation is build between internal entities and external entities with many to many relationship by creating a cross reference internal entity.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

FIG. 1 illustrates an exemplary computing system, according to one embodiment of the invention.

FIG. 2 illustrates an exemplary computing system, according to another embodiment of the invention.

FIG. 3 illustrates a method performed by unified model tool, according to one embodiment of the invention.

FIG. 4 illustrates an exemplary computing system, according to one another embodiment of the invention.

### DETAILED DESCRIPTION OF THE INVENTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the state of the arts. However, although embodiments of the invention may achieve advantages over other possible solutions and/or over the state of the art, whether or not a particular advantage is achieved by a given embodiment is not limiting of the invention. Thus, the following aspects, features, embodiments and advantages are merely illustrative and are not considered elements or limitations of the appended claims except where explicitly recited in claims. Similarly, reference to the invention shall not be construed as a generalization of any inventive subject matter disclosed herein and shall not be considered to be an element or limitation of the appended claims except where explicitly recited in claims.

Embodiments of the present invention provide application development tools that allow developers to quickly build applications while being connected and working with multiple different databases at the same time. Advantageously, embodiments of the invention provide automatic code generation, query generation for multiple databases, thereby developing a unified virtual model of databases. The unified model makes it easy for a developer to build an applications over the model without worrying about the fact that some of the models are lying in some remote data sources, such as cloud based, legacy systems or are in a different application altogether. The model saves a lot of time and help developer focus more on designing and writing code to perform intended functions of an application using connected databases.

The unified model makes it easy for the developer to build business relations between different models, databases, applications. For example, in an existing legacy application for customer database management, a new order management system is required to be build, the new unified model will link the customer data through unified model rather than replicating the customer data into a new application. Once an external customer entity is linked, an internal order entity is created and builds a relation between customer and order. After that the developer can program against these customer and order object using the API's provided in the unified model framework, as if the customer is an internal object.

The unified model also helps to avoid data duplication. In above scenario, the customer data still resides in the legacy application itself. The developer need not worry about the fact that customer data is lying in a remote legacy application. Thus, embodiments of the invention may significantly reduce application development and overhead costs.

One of ordinary skill in the art will readily recognize, however, that embodiments of the invention may be adapted for use with a wide variety of programming languages, platforms used to develop applications requiring access to multiple databases. Similarly, embodiments of the invention may be adapted for use with multiple database query languages.

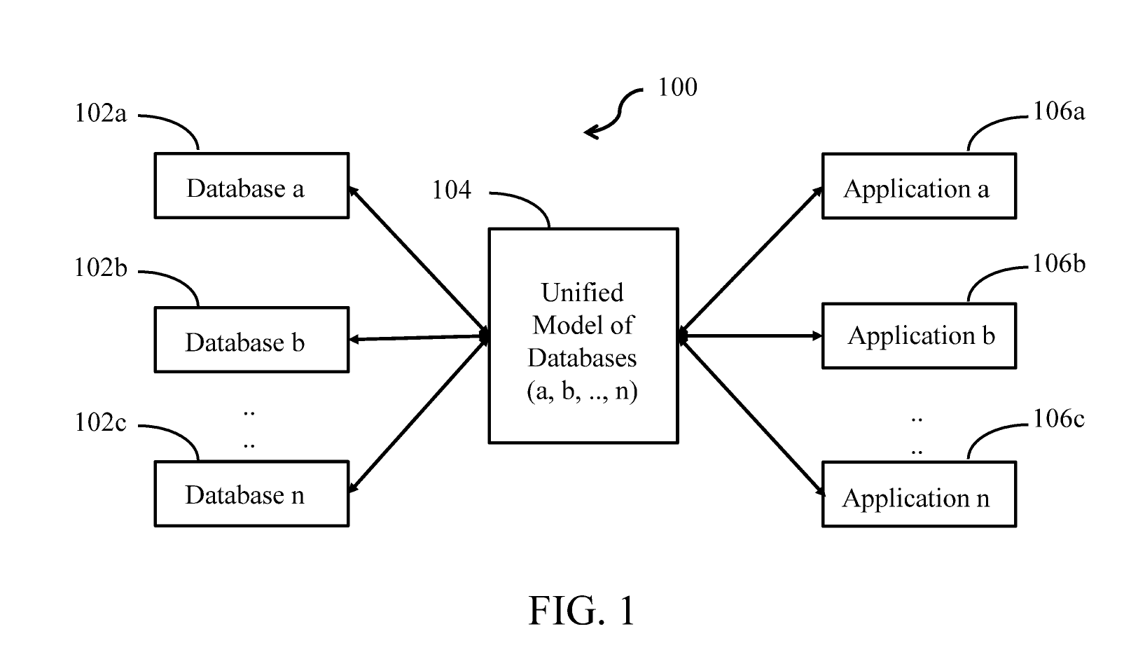

FIG. 1 is a block diagram that illustrates an example view of a computing environment 100, according to one embodiment of the invention. The computing environment 100 includes a computer system. The computer system is included to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. The system can be a single computer system, embodiments of the invention may be adapted for use on multiple computer systems configured to communicate over a network, such as, client server architectures, cloud systems, virtual machine images. Additionally, the illustration of the computer system is simplified to highlight aspects of the present invention and that computing systems and data communication networks typically include a variety of additional elements not shown in FIG. 1.

The computer system includes a processor(s), a storage device, a networking device, and a memory. The processor is a programmable logic device that executes user applications or instructions. The computer system may be connected to a display device and at least one input device(s). Typically, user input devices include a mouse pointing device and a keyboard, and display device is a CRT monitor/LCD/LED/plasma display. The processing activity and hardware resources on computer system may be managed by an operating system (not shown). Well known examples of operating systems include the Windows® operating system, distributions of the Linux® operating system, and IBM's i5/OS® operating system, among others. Network device(s) may connect computer system to any kind of data communications network, including both wired and wireless networks.

Storage device stores application programs and data for use by computer system. Typical storage devices include hard-disk drives, flash memory devices, optical media, network and virtual storage devices, and the like. The storage device(s) contains a database(s) and application development project.

Database may store a collection of data records organized according to a data model. For example, data model may provide a relational schema of tables, columns, and keys for organizing data records stored in database and accessed using database statements or other query/non-query based data retrieval methods such as SQL. The application development project represents a collection of information used to build a software application. For example, an application development project may include source code files, scripts, etc., along with resources such as fonts, images, build-instructions, and project documentation, etc.

Developers create additional components for a business application to add functionality into the application development projects. The business application may originally be developed using a business application based programming language, the developers use the same business application language to develop additional components for the application. A scripting language allows the developers to build programmable codes in the scripting language without using the business application language. The scripting language gives an additional advantage to developers to create components, programmable codes without even knowledge or expertise of the programming language of the application project. One embodiment of the invention allows use of scripting languages across unified model.

In one embodiment, database a 102a, database b 102b, database c 102c, . . . database n 102n are provided in a computing environment 100. A user interface allows a user/developer to link multiple of these databases 102a, 102b, . . . , 102n and generate a unified model of databases 104 which provides information and identifies implementation of databases, to specify details of various tables, schemas of different or same database servers and host a virtual accessing capability. The information provided by the database unified model may specify a schema of the database and various database elements. The database schema refers to metadata defining database elements and their relationships. The database elements may include, for example, database tables, indexes, stored procedures, views, etc.

Next, the virtual database model or entity model analyses usage characteristics of the database schema. This analysis may include, for example, the evaluation of the referential integrity rules defined by the database schema to determine which tables should be co-located, the evaluation of common data requests (e.g., database queries, updates, inserts, etc.) to determine which tables should be co-located to provide maximum performance of the common queries and/or updates, the evaluation of stored procedures to determine whether a stored procedure should be co-located with the tables referenced by the stored procedure, the evaluation of various database tables to find which tables can be cached for maximum performance, etc.

The virtual database model uses the analysis of the usage characteristics to decide how to unify the multiple database models over the specified number of database servers. Once the database modelling is done, the virtual database model provides access to database data for various applications including application a 106a, application b 106b, application c 106c, . . . , application n 106n and so on so forth. The applications do not need to be modified to access database data distributed over multiple servers and do not need to be aware of the specific distribution of the database models.

The embodiments of present invention include various steps, as described. The steps may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments of present invention also relate to a system for performing the operations described. The system may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented are not inherently related to any particular computer or other systems. Various general purpose systems may be used with programs or it may prove convenient to construct more specialized systems to perform the required method steps. The required structure for a variety of these systems will appear as mentioned in the description. In addition, the present invention is not described with reference to any particular programming language. It will be appreciated that a variety of programming languages may be used to implement the teachings of the invention as described.

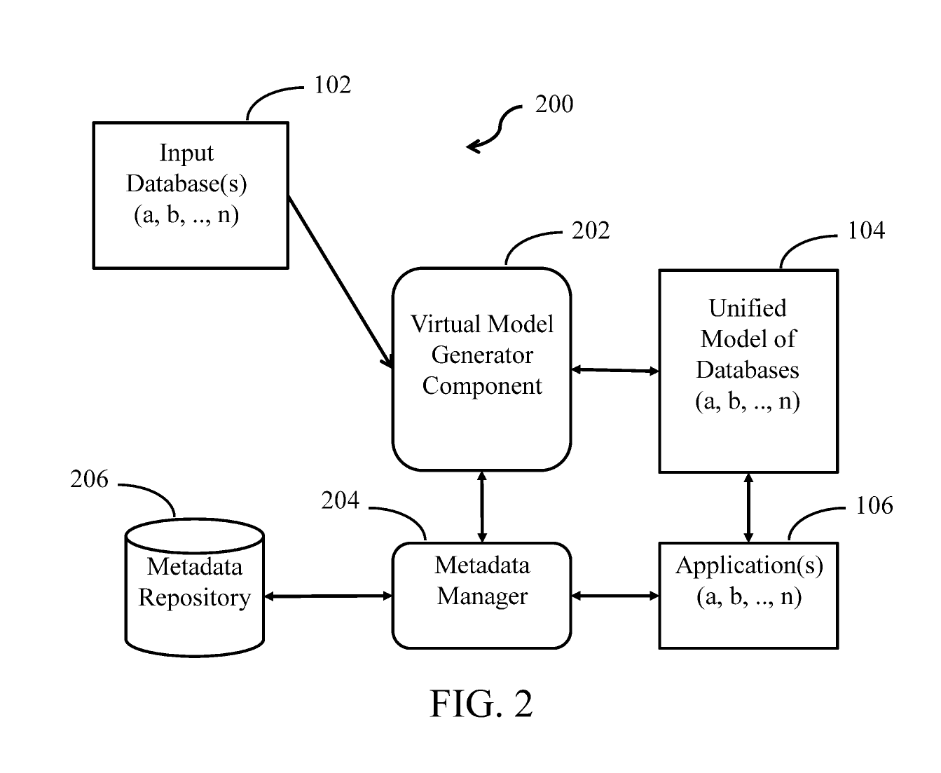

FIG. 2 illustrates an exemplary networked computing environment 200 in which embodiments of the present invention may operate. The networked computing environment 200 may include input database(s) 102 (a, b, c, . . . , n) that may be hosted by a single database server or multiple servers in a clustering-type or other environments, and/or by one or more physical machines at one or multiple locations throughout the globe.

Application(s) 106 (a, b, . . . , n) may be coupled with database servers via a network (e.g., a private network such as a local area network (LAN), or a public network such as Internet, etc.). The number of database servers 102 may be specified by a user or a database administrator (DBA) or is generally predefined by an application developer. A unified model receives information identifying an implementation of a database 102 from a client device (not shown) such as a console or personal computer of the DBA. The information identifying the database model may specify a schema of the database 102 and various database elements such as stored procedures, indexes, views, etc.

Database(s) 102 are linked to a number of software applications, including unified model of databases 104, a virtual model generator component 202, and a query tool. Also, memory includes a metadata manager 204 linked to a metadata repository 206. Virtual model generator component 202 may be a software application configured to evaluate the database and generate the schemas or virtual models of various database elements and communicate with other components of the computing environment 200. The metadata manager 204 communicates with the application(s) 106 to assist the virtual model generator service component 202 and the metadata repository 206 responsible for storing and keeping each and every metadata based database model prepared, offered and executed. The query tool may be a software application configured to execute a valid database statement (e.g., an SQL query).

The metadata manager 204 is a tool that enables metadata descriptive of attributes of data contained within databases 102 to be added to the metadata repository 206. While this selection and assignment of the metadata values may be fully or partially automated, the metadata manager 204 includes a mechanism that enables users to manually input, into metadata repository 206, a plurality of metadata tags that describe data components of one or more databases 102. In one embodiment, data tags are assigned to particular data elements as mentioned, but not limited to properties, fields, values, objects present in databases 102. In one embodiment, the metadata manager 204 enables a user to freely associate and dissociate data tags with locations within one or more databases 102.

In one embodiment, virtual model generator service component 202 is further configured to translate requests for data received from the application 106 by identifying the corresponding generated database query statements. The corresponding database query statements are executed so as to retrieve corresponding data from the database(s) 102. That retrieved corresponding data is then delivered to the application 106 in response to their request. The data is illustratively delivered through a traditional data protocol such as, but not limited to, TCP/IP, HTTP, SOAP, REST, etc. The physical delivery mechanism is client and configuration dependent. Delivery can be in a format that is consumable on all platforms.

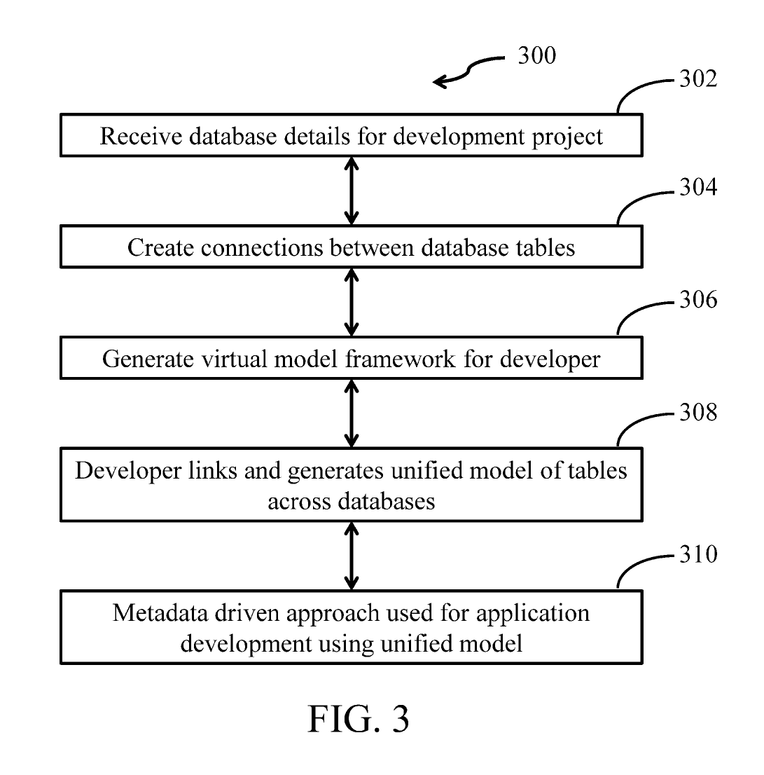

FIG. 3 illustrates a method performed by unified model tool, according to one embodiment of the invention. A computing environment 300 shows an embodiment of the invention that provides a virtual database model tool for quick application development across multiple platforms for unique but easily accessible virtual model delivering all the requisites of data access, linking, security, inter-operability, ease of maintenance, consistency and referential integrity.

One embodiment of the invention includes a method for providing a platform with a unified framework having a single virtual model of tables from one or multiple databases are inputted 302, further, linking across tables belonging to the one or multiple databases is performed 304, thereby assisting in creation of new models around databases 306, and generating a unified view of the models 308, without reference that the models belong to different multiple databases.

Another embodiment of the present invention includes a method or system wherein a unified model by a metadata driven approach 310 is used for the application development, wherein dragging and dropping creates the application screens.

Still further, by providing the virtual database unified model functionality, embodiments of the invention may be used to test database connectivity and functionality for a multi database dependent application using the same virtual model generator service component.

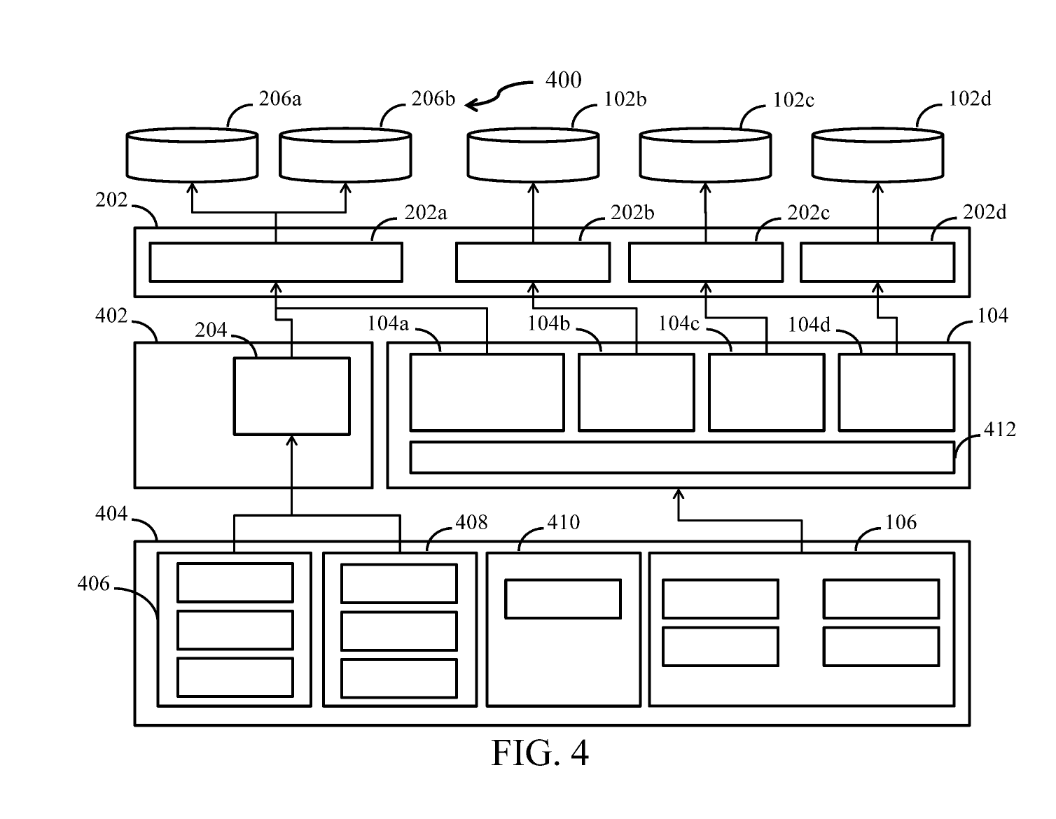

FIG. 4 illustrates an exemplary networked computing environment 400 in which embodiments of the present invention may operate. Unified model of the present invention for an application development process provides an application layer in which developers can set programming standards through a customizable template. In setting these standards, the developer defines a standard framework that can be customized and linked to building blocks by various components, utilities, and project functionalities, to implement standard business rules in an assembled code.

The application layer 404 has applications (a, b, . . . n) 106, admin functions 406, rapid app builder 408, app development framework 410. The admin functions 406 include users and organisational details, app manager, security policies and functions. The rapid app builder 408 has several data modellers, form builder components, workflow chart and structures. Further, the app development framework 410 includes POJO objects which generally allow access to properties using different methods. The applications 106 has various business application based CRM, project management, timesheet, service request etc. details. The application layer 404 may include other utilities and also perform functions that include template assignment, script validation, global variable, code check configuration, program specification building, class building, code generation, virtual configuration, business rule editor, etc. The application is also composed of a software project layer, templates, JAVA classes.

The application layer 404 can be used to define templates or creating classes, methods, program specifications, validation routines, naming rules among other uses. The application 106 of the application layer 104 communicates with the model layer 104 also involving in memory data for reporting 412. The database models 104a, 104b, 104c, . . . , 104n includes the industry available databases (DB) such as DB2 DB models, Oracle DB models, SqlServer models along with the unified DB model in line with the embodiments of the present invention.

The DB models 104a, 104b, . . . , 104n of the model layer 104 communicates with the connection layer 202, the unified DB model 104a connects to the virtual model generator component 202a of the connection layer 202 along with the metadata manager 204 inputs of metadata layer 402. The virtual model generator component 202a further links the metadata repository 206 with a metadata DB 206a and a data DB 206b and the like. The connection layer 202 has other respective model generator component or connections 202b, 202c, . . . , 202n to the DB models 104b, 104c, . . . , 104n and in turn communicates with the customer databases 102b, 102c, . . . , 102n.

The metadata manager 204 is a tool that enables metadata descriptive of attributes of data contained within databases 102 to be added to the metadata repository 206 resides at metadata layer 402 and also communicates with the application layer 404 components including admin 406, rapid app builder 408, and others.

The various embodiments of the present invention can use any relational or non-relational databases, such as DB2, Oracle, SQLserver, Informix, Sybase, and can run on computers using IBM OS/2, Microsoft Windows NT, IBM-AIX, HP-UX, Sun Solaris, and other operating systems. The embodiments of the present invention include a method or system wherein application development targets these unified models and the framework will take care of directing or getting the data from underlying databases. Multiple databases such as SQL databases like MySQL, Oracle, SQL Server, DB2; noSQL databases like MongoDB, any webservices that provides access to data, file systems etc. can be supported through this framework. A database is any collection of information that is organized so that it can easily be accessed, managed, and updated. Which can be a relational DB, non-relational DBs like network DB, nosql DB, file systems or even other applications acting as data sources for databases Unified Platform can also have its own database and entity models.

The unified model generates a unified platform to bring the entity model from different external databases for use in building software application. A database is any collection of information that is organized so that it can easily be accessed, managed, and updated, which can be a relational DB, non-relational DBs like network DB, nosql DB, file systems or even other applications acting as data sources for databases. The unified platform can also have its own database and entity models.

Metadata of these external and internal entities are kept in the unified platform. The system provides a way to build a unified model using these entities. The unified platform provides data modeler to build and manage entities and its relations.

The unified model works with elements of application, data model, model generator component, database in one to one (1:1), one to many (1:N), many to one (N:1), and many to many (N:N) build relationships.

Unified platform exposes APIs to query, insert, update and delete data from these external and internal entities in a standard uniform way. This helps the software developers using this platform to develop application with multiple database or data sources without worrying about the underlying complexities. The unified platform provides custom connectors to be plugged in for any external data sources. These connectors translate the standard unified API calls to external data source specific calls. Custom connectors will be developed using Custom connector interface which will be exposed so that anyone can use this interface to develop a custom connector to plug an external data source to this unified platform.

Custom connector interface will have 5 interface methods. All input and output to these functions will be in a standard JSON format, such as GetModel( ) that returns the external entities that needs to be exposed from external datasource, its metadata and relations in an JSON Format, QueryData( ) that pass entity name to Query and Criteria and Columns needed to return and returns the Result dataset, InsertData( ) that Pass Entity name to Insert and Data, UpdateData( ) that Pass Entity name to Update, Criteria and Data, DeleteData( ) that Pass Entity name to Delete and Criteria.

One entity models is build and at least one relation between internal entities and external entities are created. The 1:N relations are build between internal entities and external entities by adding the reference keys of external entities in the metadata of internal entity. The additional fields will be added to the internal entity and related data is kept in the internal entity table. The 1:N Relations can also be build between two external entities by adding the reference keys of one entity to other entity in metadata. A cross reference internal table will be kept in the unified platform to keep the relation and related data between these entities. The N:1 Relations are build between internal entities and external entities by adding the reference keys of internal entity to external entity metadata. A cross reference internal table will be kept in the unified platform to keep the relation and related data between internal entity and external entity. Further, the N:N relations are build by creating a cross reference internal entity. The relations can be made readily available and as templates for future application usage to same or different set of users/developers.

One embodiment of the invention is implemented as a program product for use with a computer system. The programs of the program product define functions of the embodiments, including the methods described herein, and can be contained on a variety of computer-readable storage media. Illustrative computer-readable storage media include, but are not limited to non-writable storage media for e.g., read-only memory devices within a computer such as CD-ROM disks readable by a CD-ROM drive on which information is permanently stored, writable storage media for e.g., writable DVDs, RW-CDs, and hard-disk drives on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Another embodiment of the present invention includes identifying one or more database tables that are to be cached to improve performance, plurality of database tables that are to be cached comprise one or more of static tables and commonly accessed tables. The determining of the layout of the database implementation comprises determining which tables need to be co-located for the common data requests.

Yet another embodiment, analyses stored access codes associated with a database schema, and for each stored access code, determining whether database tables are referenced by the stored access code and hosted by one of the database servers or by two or more of the database servers. Deciding and storing the access code on a primary or hosting database server or on a virtual database server.

Another embodiment of the present invention allows a user/developer to manually update the layout of the unified model framework over the plurality of database servers and providing performance hints for the updated layout.

Another embodiment of the present invention includes periodically optimizing the layout of the database implementation over the identified plurality of database servers.

Modifying contents of a local cache storing one or more database tables and logging additional data requests received from the one or more applications. Further, determining which of the additional data requests are additional and periodically re-distributing the layout of the database implementation based on the additional common data requests.

Another embodiment of the present invention includes storing mappings between the database virtual model and the databases on the metadata repository or other memory mediums/servers. A second storage system is provided as a standby database.

Another embodiment of the present invention includes a query engine communicating with said interface, for executing a query to the federated schema and for returning query results. The query engine is a software application, a component of a business intelligence tool, or a component of a business process management environment.

Another embodiment of the present invention includes a database view formulated using SQL statements or other query statements. Data constructs, business rules, views, are manually or automatically generated and embeds into each other or other data elements by user or automatically.

Another embodiment of the present invention includes meta data which is data for managing or representing the database and includes a uniform resource locator (URL) indicating the location of the database, the name of the database, and the type of the database, or a combination of these.

Another embodiment of the present invention includes a query processing unit which receives a query on desired data from a user and divides the query into local queries for each of the dispersed databases. Further, a controller or controlling various aspects of the computing environment including but not limited to the databases, applications, virtual model generator component, query generator, metadata manager, metadata repository, unified model of databases.

Another embodiment of the present invention includes a schema controller which parses a specification language document on the database and generates meta data, and if the database is a local database, generates a local schema for each item of the parsed specification language document, and if the database is not a local database, parses the input query and generates a global schema for each item of a return clause included in the parsed query.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

1. A method to generate an entity model, comprising:
receiving a selection of one or more databases;
receiving connection specifying between data elements of one or more databases and setting of connection;
retrieving a data model of one or more databases, the data model comprising a set of database elements;
generating a virtual model framework of one or more databases.

2. The method as claimed in claim 1 further comprising, generating a unified platform using the entity model from one or more databases to build an application.

3. The method as claimed in claim 1, wherein the retrieving further comprises collecting metadata of the data models and storing in a metadata repository.

4. The method as claimed in claim 2, wherein the unified platform exposes application program interface to edit data from internal entities or external entities.

5. The method as claimed in claim 2, wherein the unified platform provides custom connectors to be plugged in for any external data sources.

6. The method as claimed in claim 2 further comprising, building at least one entity models and at least one relation between internal entities and external entities.

7. The method as claimed in claim 6, wherein the relation is build between internal entities and external entities with one to many relationship by adding reference keys of external entities in metadata of internal entity.

8. The method as claimed in claim 6, wherein the relation is build between two external entities with one to many relationship by adding reference keys of one entity to other entity in metadata.

9. The method as claimed in claim 6, wherein the relation is build between internal entities and external entities with many to one relationship by adding reference keys of internal entity to external entity metadata.

10. The method as claimed in claim 6, wherein the relation is build between internal entities and external entities with many to many relationship by creating a cross reference internal entity.

11. A system, comprising:
a processor; and
a memory containing a virtual model generator component configured to generate virtual model framework of one or more databases, performing an operation, comprising:
receiving a selection of one or more databases;
receiving connection specifying between data elements of one or more databases and setting of connection;
retrieving a data model of one or more databases, the data model comprising a set of database elements;
generating a virtual model framework of one or more databases.

12. The system as claimed in claim 11 comprising, wherein the virtual model framework further generates a unified platform from one or more databases to build an application.

13. The system as claimed in claim 11, wherein the retrieving further comprises collecting metadata of the data models and storing in a metadata repository.

14. The system as claimed in claim 12, wherein the unified platform exposes application program interface to edit data from internal entities or external entities.

15. The system as claimed in claim 12, wherein the unified platform provides custom connectors to be plugged in for any external data sources.

16. The system as claimed in claim 12 further comprising, building at least one entity models and at least one relation between internal entities and external entities.

17. The system as claimed in claim 16, wherein the relation is build between internal entities and external entities with one to many relationship by adding reference keys of external entities in metadata of internal entity.

18. The system as claimed in claim 16, wherein the relation is build between internal entities and external entities with many to one relationship by adding reference keys of internal entity to external entity metadata.

19. The system as claimed in claim 16, wherein the relation is build between internal entities and external entities with many to many relationship by creating a cross reference internal entity.

20. A computer program product comprising a computer useable storage medium having a computer readable program, wherein the computer readable program when executed on a computer causes the computer to perform an operation comprising:
receiving a selection of one or more databases;
receiving connection specifying between data elements of one or more databases and setting of connection;
retrieving a data model of one or more databases, the data model comprising a set of database elements;
generating a virtual model framework of one or more databases.
